(19) United States
(12) Patent Application Publication
(10) Pub. No.: US 2026/0162198 A1
(43) Pub. Date: Jun. 11, 2026

(54) HYBRID ARTIFICIAL INTELLIGENCE SOLUTION

(71) Applicant: Expedia, Inc., Seattle, WA (US)

(72) Inventors: Goli Cobbe, Danville, CA (US); Andrew James Pavlosky, Seattle, WA (US); Jonathan Scott Noblit, Seattle, WA (US); Danny Godbout, Seattle, WA (US); Abishek Ashok, Menlo Park, CA (US); Ryan Michael Hillman, Seattle, WA (US)

(21) Appl. No.: 19/410,915

(22) Filed: Dec. 5, 2025

Related U.S. Application Data
(60) Provisional application No. 63/730,370, filed on Dec. 10, 2024.

(51) Int. Cl. G06Q 50/14; G06F 40/40

(52) U.S. Cl. CPC G06Q 50/14; G06F 40/40

(57) ABSTRACT

Systems and methods are described for providing personalized travel experiences to a user. In some implementations, a user query related to a request to generate travel recommendations is obtained. The systems and methods can access the user data store to obtain user profile data. Based at least in part of the user profile data, the systems and methods can utilize a case-specific user analysis model to determine the user's specific travel preferences. Based at least in part on the user's specific travel preferences and query, the systems and methods can generate a prompt to input to an LLM. The LLM can output personalized travel recommendations based at least in part on the input prompt to provide to the user.

### PRIORITY AND INCORPORATION BY REFERENCE

This application claims benefit under 35 U.S.C. § 119(e) of U.S. Provisional Patent Application Ser. No. 63/730,370, entitled “HYBRID ARTIFICIAL INTELLIGENCE SOLUTION,” filed Dec. 10, 2024, the full disclosure of which is hereby incorporated by reference for all purposes herein.

### BACKGROUND

Artificial intelligence (“AI”) models have grown in functionality and popularity in the technology field. In some cases, generative AI has become the cornerstone in enhancing offerings to consumers of websites, mobile applications, and other experience interfaces. For example, generative AI has been utilized to create chat bots for many online services. Accordingly, developers may choose to try different approaches to utilizing AI to further improve their services.

### BRIEF DESCRIPTION OF THE DRAWINGS

The following drawings and the associated descriptions are provided to illustrate embodiments of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1 is a schematic block diagram of an example network environment in which a hybrid AI model approach may operate, according to various aspects of the present disclosure.

FIG. 2 is a block diagram of an example data flow in which the hybrid AI model approach may operate, according to various aspects of the present disclosure.

FIG. 3 is a flow diagram showing an example routine for providing a restaurant recommendation, according to various aspects of the present disclosure.

FIG. 4 is a flow diagram showing an example routine for providing an activity recommendation, according to various aspects of the present disclosure.

FIGS. 5A-5G are example user interfaces of the hybrid AI model that may be generated for presentation by a client application, according to various aspects of the present disclosure.

FIG. 6 is a block diagram illustrating components of an example computing device that can be used to implement the various systems and methods described herein.

### DETAILED DESCRIPTION

Aspects of the present disclosure relate to the use of two sequential or concurrent machine learning or artificial intelligence models (also referred to as a hybrid AI system), wherein the output of the analytical model (the first model in a two-model architecture) is combined with a custom input query to create a hyper-personalized prompt for a generative AI model (the second model in a two-model architecture or sequence). The generative AI model then offers travel recommendations to the user and/or creates an itinerary for the user as output. In some embodiments, the two machine learning or artificial intelligence models may operate sequentially, where the analytical model processes user data first, and its output is subsequently used as input for the generative AI model. In other embodiments, the models may operate concurrently, such as when multiple analytical models process different aspects of user data in parallel to generate distinct outputs that are later combined into a single prompt for the generative AI model. The hybrid AI system addresses the limitations of single-model systems, such as hallucinations, lack of personalization, and high computational costs, by leveraging the complementary strengths of the analytical and generative AI models. This flexibility allows the system to adapt to different use cases, computational constraints, and user requirements.

Some systems allow for the use of either a single analytical machine learning model, or a single generative machine learning model. While both analytical and generative models have their benefits, there are also limitations present. For example, generative AI may output hallucinations (e.g., incorrect, or misleading results) as true and convincing results, leaving the user open to risk if they rely on the generative AI's output. As another example, generative AI models have a higher computation time compared to more analytical AI models (e.g., one second computation time compared to 1/10 second computation time).

As yet another example, output from generative AI models is not generally personalized to the user's specific case. Generative AI models are trained in large data sets, so most users inputting a similar prompt will receive similar responses, particularly if the user has not previously interacted significantly with the model. Including specific, hyper-personalized information in the prompt can combat this issue; however, users may not know the benefits of including specific information or may not have a sense of what personalization information or other contextual information would lead to desired results from a particular generative model.

Analytical models (which may include but are not limited to machine learning model types such as classification models and regression models) also have limitations that cannot be addressed without the help of generative AI. For example, some types of analytical AI or machine learning (“ML”) models rely on predefined instructions and/or make decisions based on statistical reasoning. Therefore, while many analytical AI or ML models may excel at performing repetitive tasks or solving well-defined problems, they may lack the ability to adapt to generate novel solutions or to generate meaningful output from input that departs significantly from their training data or manually coded instructions.

As another example, analytical AI models (as opposed to a generative model type, such as a large language model) cannot typically understand the nuances of human language. This lack of understanding creates issues for the analytical AI models in situations where custom human-created queries may be the input to the model.

Aspects of the present disclosure address some or all of the issues noted above, among others, by combining an analytical AI model with a generative AI model to create a hybrid, two-model approach. With this approach, the hybrid AI system can utilize the analytical AI model to create a personalized prompt containing information pertaining to the user's preferences and combine that output with the user's custom input query to create a hyper-specified prompt to input to the generative AI model. This hybrid approach can operate in a sequential or concurrent manner, depending on the use case, to optimize performance and personalization. This approach is beneficial to overcoming the limitations of using either an analytical AI model or generative AI model alone.

For example, by first utilizing an analytical AI model to refine a user's preferences based on data such as a user profile of the user and/or prior user behavior of the user with a different system, the generative AI model can be fed a more user-specific and well-defined prompt, lowering the risk of hallucinations or generic output that is not particularly relevant to the given user. For example, the analytical AI model may refine user preferences (and thus, the prompt fed to the generative AI model) based on data such as demographic information, travel history, or prior interactions with the system.

As another example, the overall computation time of the hybrid AI system can be lowered by utilizing an analytical AI model to take some of the computational load from a generative AI model. By asking a generative AI model to generate output based on previously summarized knowledge or personalized contextual information, the computational time required by the generative AI model is lower compared to sending in a breadth of knowledge to the generative AI model to be summarized.

As yet another example, by taking user preferences, intent, and other data related to the user's travel experience as input, an analytical AI model can create a hyper-personalized dataset as output to then be combined with the user's custom query into a prompt for the generative AI model. Such a prompt may be referred to herein as a “hyper-personalized” prompt. While the output of a generative AI model might generally be overbroad or somewhat user-agnostic, the inclusion of the analytical AI's user specific output can allow the generative AI model to create a much more personalized response and/or itinerary for the user to choose from. Furthermore, by utilizing an analytical AI model to personalize the prompt, the user will not have to answer questions about their preferences to personalize the prompt on their own.

As another example, by feeding the output of the analytical AI into a generative AI model, a two-AI hybrid approach can output a novel solution to the user's query. The two-AI hybrid approach allows the hybrid AI system to utilize both the statistical reasoning that analytical AI models excel at and the novel reasoning that generative AI models excel at once.

As another example, since analytical models are not well suited to receive custom input, the analytical model can focus on identifying a user's relevant data and known preferences and can allow the generative AI model to process the custom user query.

The above-described aspects and other aspects of the disclosure will now be described with regard to certain examples, embodiments, and aspects, which are intended to illustrate but not limit the disclosure. Although the examples, embodiments, and aspects described herein will focus on, for the purpose of illustration, specific calculations and algorithms, one of skill in the art will appreciate the examples are illustrative only and are not intended to be limiting.

### I. Example Network Environment Utilizing the Hybrid AI System

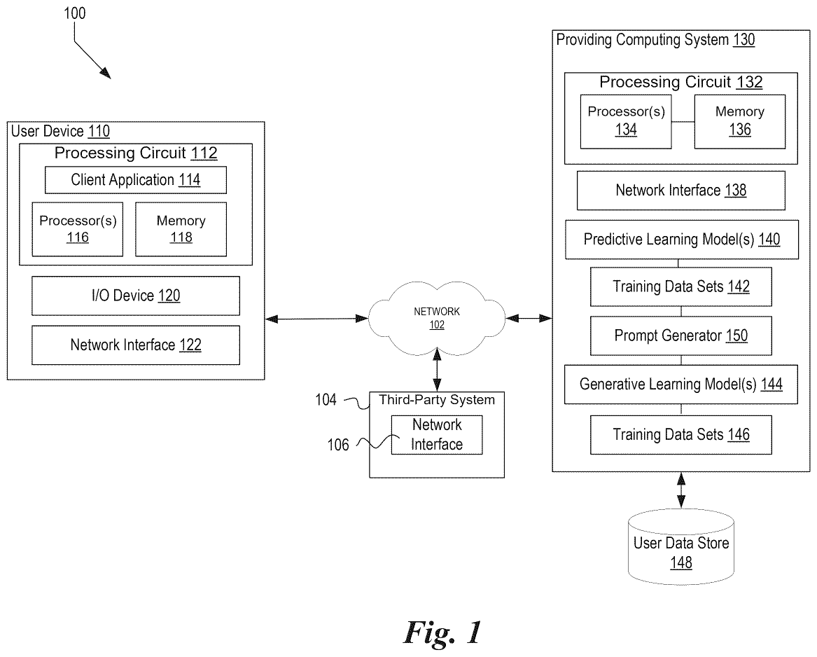

With reference to an illustrative example, FIG. 1 is a schematic block diagram of an example network environment 100 in which a network-based two-model hybrid approach (also referred to as a hybrid AI system) may operate, according to various aspects of the present disclosure. The hybrid AI system includes predictive learning model(s) 140 (which may correspond to the analytical AI models described above), a prompt generator 150, and generative learning model(s) 144 (which may correspond to the generative AI models described above). The network environment 100 includes a third-party system 104, a user device 110, and a providing computing system 130, all in communication with each other through the network 102. The network environment 100 may also include a user data store 148, which is in communication with the providing computing system 130.

The network 102 can include any appropriate network, including wired network, wireless network, or combination thereof. For example, network 102 may be a personal area network, local area network, wide area network, cable network, satellite network, cellular network, or any other such network or combination thereof. As a further example, the network 102 may be a publicly accessible network of linked networks, possibly operated by various distinct parties, such as the Internet. The network 102 may include one or more wireless networks, such as a Global System for Mobile Communications (GSM) network, a Code Division Multiple Access (CDMA) network, a Long-Term Evolution (LTE) network, C-band, mmWave, sub-6GHz, or any other type of wireless network. The network 102 can use protocols and components for communicating via the Internet or any of the other aforementioned types of networks. For example, the protocols used by the network 102 may include Hypertext Transfer Protocol (HTTP), HTTP Secure (HTTPS), Message Queue Telemetry Transport (MQTT), Constrained Application Protocol (CoAP), and the like. The network 102 facilitates communication between the user device 110, the third-party system 104, and the providing computing system 130, enabling the hybrid AI system to process user queries and generate personalized travel recommendations.

The third-party system 104 provides review data and/or other data regarding various travel recommendation options (e.g., hotels, restaurants, travel destinations, travel activities, etc.) to the providing computing system 130. The third-party system 104 may interface with the providing computing system 130 via the third-party network interface 106. For example, in some embodiments, a providing computing system 130 may operate a review service to obtain reviews and preferences pertaining to the user's (and other users') previous experiences with specific restaurants, activities, etc. The providing computing system 130 may then store the user's responses to this review in the user data store 148, where the predictive learning model(s) 140 can access the data to refine user preferences.

The user device 110 allows the user to interact with the providing computing system 130. The user device 110 includes a processing circuit 112, an input/output (“I/O”) device 120, and a network interface 122. The processing circuit includes the client application 114, one or more processors 116, and memory 118. The user device may be a mobile computing device such as a smartphone or tablet, or it may be any other form of computing device. Through the client application 114, the user can submit custom queries to the hybrid AI system implemented by the providing computing system 130 and receive personalized travel recommendations generated by the generative learning model(s) 144, based on outputs from the predictive learning model(s) 140. In some embodiments, the predictive learning model(s) 140 generate prompts that the generative learning model(s) 144 can use to generate the personalized travel recommendation. In another embodiment, the prompt generator 150 can refine the predictive learning model(s) 140 to generate a hyper-personalized prompts. For example, the prompt generator 150 may combine outputs from the predictive learning model(s) 140 with the user's custom input query to generate the hyper-personalized prompt (also referred to as hyper-specified prompt) that includes additional personalization or refinement. The hyper-personalized prompt may then be provided to the generative learning model(s) 144. The prompt generator 150 may, in some embodiments, operate as an intermediary between the predictive learning model(s) 140 and the generative learning model(s) 144, and may facilitate the integration of user-specific preferences and query data into the input provided to the generative learning model(s) 144.

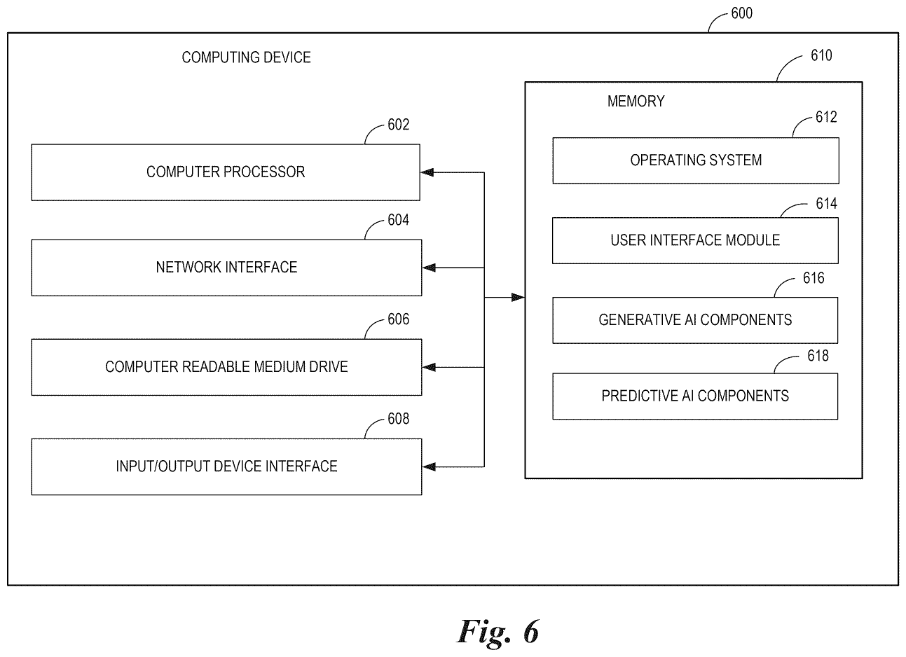

The processing circuit 112 allows the user device 110 to access the client application 114. The processing circuit 112 utilizes the one or more processors 116 and memory 118 to access the client application 114 and its services. The client application 114 contains the services provided by the providing computing system 130, as described below. The processing circuit 112 enables the user device 110 to interact with the hybrid AI system by accessing the client application 114, which facilitates communication with the providing computing system 130. The one or more processors 116 and memory 118 are described in more detail with respect to FIG. 6 below.

The I/O device 120 on the user device 110 allows the user to receive output from the providing computing system 130. Furthermore, the I/O device 120 allows the user to input their custom user query into the hybrid AI model (also referred to as the hybrid AI system) implemented by the providing computing system 130, and subsequently receive as output a list of travel recommendations and/or a custom-built itinerary for their travel. The I/O device 120 enables the user to interact with the hybrid AI system by inputting custom queries and receiving personalized outputs generated by the generative learning model(s) 144. The I/O device 120 is described in more detail with respect to FIG. 6 below.

The network interface 122 allows the user device 110 to interact, via the network 102, with the providing computing system 130 and the third-party system 104. The network interface 122 enables the user device 110 to interact with the hybrid AI system by transmitting user queries and receiving personalized outputs generated by the generative learning model(s) 144. The network interface 122 is described in more detail with respect to FIG. 6 below.

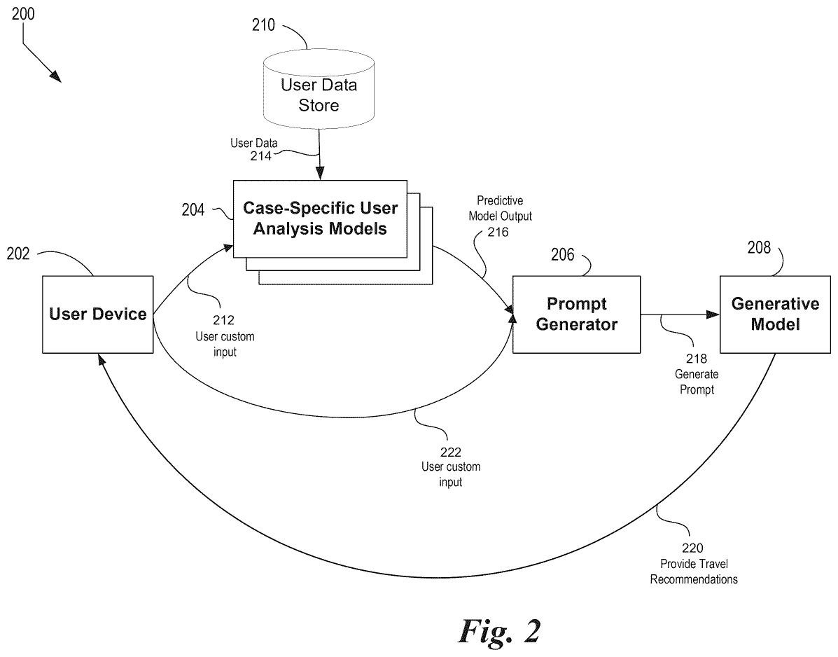

Within network environment 100, the providing computing system 130 operates via the client application 114 to provide the user device 110 travel information. The providing computing system 130 may provide the user device 110 with the ability to manage their own travel itinerary, choose from a list of available restaurant options, activities, etc. The providing computing system 130 includes a processing circuit 132, a network interface 138, predictive learning model(s) 140 (also referred to as case-specific user analysis models described in more detail with respect to FIG. 2 below), a plurality of training data sets 142 for the predictive learning model(s) 140, the prompt generator 150, the generative learning model(s) 144, and training data sets 146 for the generative learning model(s) 144. The providing computing system 130 implements the hybrid AI system, combining predictive learning model(s) 140 and generative learning model(s) 144 to process user queries and generate personalized outputs. The processing circuit 132 includes one or more processors 134 and memory 136 used to operate the providing computing system 130. The one or more processors 134 and memory 136 act the same as/similar to the one or more processors 116 and memory 118.

The network interface 138 allows the providing computing system 130 to interact, via the network 102, with the user device 110 and the third-party system 104. In some embodiments, the hybrid AI system may be distributed across multiple computing systems, with network interfaces enabling communication between distributed components such as the predictive learning model(s) 140, the prompt generator 150, and the generative learning model(s) 144. The network interface 138 acts the same as/similar to the network interface 122.

The predictive learning model(s) 140 may include one or more AI models trained on specific data sets. The term “model” or “AI model,” as used in the present disclosure, can include any computer-based models of any type and of any level of complexity, such as any type of sequential, functional, or concurrent model. Models can further include various types of computational models, such as, for example, artificial neural networks (“NN”), language models (e.g., large language models (“LLMs”)), artificial intelligence (“AI”) models, ML models, computer vision models, multimodal models (e.g., models or combinations of models that can accept inputs of multiple modalities, such as images and text), and/or the like. In the hybrid AI system, the predictive learning model(s) 140 can analyze user data to generate personalized prompts that are used as input for the generative learning model(s) 144. For example, the predictive learning model(s) 140 may analyze user preferences stored in the user data store 148 to generate a prompt tailored to the user's travel needs (e.g., the hyper-personalized prompt).

In some embodiments, the predictive learning model(s) 140 may be referred to as an analytical model that performs predictive tasks by analyzing input data and generating structured or intermediate outputs, such as classifications, embeddings, or structured summaries.

In another embodiment, the predictive learning model(s) 140 can analyze user data to generate intermediate outputs, such as structured data, narrative text, or embeddings, that represent user-specific preferences or context. These intermediate outputs are then provided to the prompt generator 150, which combines them with the user's custom query to generate the hyper-personalized prompt. The prompt generator 150 refines the predictive learning model's outputs by integrating user-specific data with the intent and context of the user's query. This refinement process may involve rephrasing, restructuring, or augmenting the combined input to ensure it is both contextually relevant and optimized for the generative learning model(s) 144. For example, the predictive learning model(s) 140 may output a preference such as “user prefers Italian cuisine,” which the prompt generator 150 combines with a user query like “Find nearby restaurants” to generate a refined prompt such as “Generate a list of family-friendly Italian restaurants within walking distance of the user's hotel.” This hyper-personalized prompt is then provided to the generative learning model(s) 144, which uses it to generate personalized travel recommendations or itineraries tailored to the user's specific needs.

The predictive learning model(s) 140 may include one or multiple models each trained on data sets containing information pertinent to the specific user. In some embodiments, the predictive learning model(s) 140 can include trip-agnostic user analysis models, which analyze general user preferences that are not specific to a particular planned trip but instead relate to broader information about the user across many trips and/or trip types. In some cases, a trip-agnostic user analysis model (where trip-agnostic refers to modeling of information about a user that is not specific to a particular planned trip, but instead relates to more general information about the user across many trips and/or trip types). In this case, the trip-agnostic user analysis model may be trained on data sets containing static user information. Static user information is user information that generally remains consistent across trips the user has booked. For example, the trip-agnostic user analysis model may be trained on user information such as the user's demographic information (e.g., family size, general size of traveling group, etc.), the user's typical travel budget (e.g., flights, meals, etc.), the user's typical airport of origin (e.g., where they live and/or where they typically begin their trip), and/or any other travel detail that typically does not change frequently for a given user on a trip-by-trip basis. The outputs from trip-agnostic user analysis models may be combined with outputs from case-specific user analysis models (described in more detail with respect to FIG. 2 below) to create hyper-personalized prompts for the generative learning model(s) 144.

In further cases, the predictive learning models 140 may include one or more case-specific user analysis models that are each trained on data sets containing information pertinent to a specific aspect of travel and/or specific trip type. The predictive learning model(s) 140 can include case-specific user analysis models that analyze specific aspects of user preferences based on the user's custom query. The specific user analysis model to be used in a given instance may be chosen based on the custom user input query. For example, a case-specific user analysis model may be a restaurant specific user analysis model. The restaurant specific user analysis model may be chosen if the custom user input asks for “restaurants in the area,” “best places to eat in Bora Bora,” or the like. Similarly, an activity specific user analysis model may be chosen if the custom user input asks for “activities to do in the area” or “things to do in Denver,” or the like. In some instances, a user request to generate a travel itinerary may invoke the trip-agnostic user analysis model and multiple case-specific user analysis models (e.g., one tailored to hotel preferences, one tailored to activity preferences, one tailored to restaurant preferences, etc.). The outputs from the trip-agnostic user analysis model and multiple case-specific user analysis models may be combined using the prompt generator 206 as described in connection with FIG. 2, to create hyper-personalized prompts for the generative learning model(s) 144.

The predictive learning model(s) 140 may take as input user data from the user data store 148 to determine the user's preferences that are relevant to the given use case (e.g., preferences relevant to restaurant recommendations for a restaurant-specific model). For example, the predictive learning model(s) 140 can include a case-specific user analysis model that may use the user preferences in order to create as output a prompt for an LLM or an embedding that contains hyper-personalized information about the user's preferences. As in the above example, a restaurant specific user analysis model may take as input information from the user data store 148 pertaining to the user's recent dining choices and experiences in order to output a prompt that may state, “user prefers Italian cuisine.” As another example, a trip-agnostic user analysis model may take as input information from the user data store 148 that the user is travelling with their two children, in which case the output prompt may state, “the user is looking for a restaurant that is family friendly.” As discussed below, it will be appreciated that depending on the model type, the output of the case-specific user analysis models may be narrative text (e.g., a text prompt to be provided to a subsequent generative model, such as an LLM), enumerated or structured data types (e.g., a classification output), or an embedding generated in a particular embedding space associated with the model.

The output from the predictive learning model(s) 140 may be human readable text, such as, “I prefer Italian restaurants that are located nearby my hotel, are affordable, and the restaurant must be suitable for children to attend.” This output would then be combined with custom user input such as “Please show me a list of nearby restaurants,” to create a hyper-personalized prompt for the generative AI model. In some embodiments, the predictive learning models 140 may generate outputs that are tailored to specific aspects of the user's query, which are then used to refine the input provided to the generative learning model(s) 144.

Additionally or alternatively, the output from the predictive learning model(s) 140 may be in the form of an embedding. Generative AI models will take in human readable prompts and convert that text into more usable embeddings (e.g., information vectors). In some embodiments, the output from the predictive learning model(s) 140 may be in the form of one or more embeddings, which, when combined with the user custom input query, will reduce the computational load on the generative AI model when parsing the input. For example, embeddings generated by the predictive learning models 140 may encode user preferences, such as “family-friendly restaurants” or “Italian cuisine,” in a format that is directly usable by the generative learning model(s) 144.

Before implementation, the predictive learning model(s) 140 will be trained on the training data sets 142. Accordingly, one of the training data sets 142 may correspond to one of the predictive learning model(s) 140. For example, a training data set 142 pertaining to restaurant recommendations will be used to train a case-specific user analysis model that is used to output user preferences pertaining to restaurant recommendations (e.g., types of cuisine the user prefers). The training data set 142 pertaining to restaurant recommendations may be pre-tagged with explicit details about the restaurants that the user is known to like (e.g., cuisine types). The corresponding case-specific user analysis model may then be trained to predict those restaurant preferences and to add those preferences to the generative learning model(s) 144 input prompt.

In some embodiments, the predictive learning model(s) 140 can be trained (with the training data sets 142) and executed on the user device 110 via the client application 114. For example, the predictive learning model(s) 140 may be configured to operate locally on the user device 110 to analyze user data stored in the user data store 148 and generate outputs such as personalized prompts or embeddings. Alternatively, the predictive learning models 140 may be executed on the providing computing system 130, allowing for centralized processing and access to larger training data sets 142. In either case, the outputs generated by the predictive learning models 140 can be used to create hyper-personalized prompts for the generative learning model(s) 144.

In some embodiments, the generative learning model(s) 144 is a Large Language Model (“LLM”). An LLM is any algorithm, rule, model, and/or other programmatic instructions that can predict the probability of a sequence of words. The generative learning model(s) 144 may, given a starting text string (e.g., one or more words), predict the next word in the sequence. The generative learning model(s) 144 may calculate the probability of different word combinations based on the patterns learned during training (as described herein). The generative learning model(s) 144 may generate many combinations of one or more next words (and/or sentences) that are coherent and contextually relevant. In some embodiments, the generative learning model(s) 144 may also be referred to as a computational model. For example, the generative learning model(s) 144 may be referred to as a computational model when generating recommendations from input prompts provided by the prompt generator 150. Thus, the generative learning model(s) 144 can be an advanced artificial intelligence algorithm that has been trained to understand, generate, and manipulate language. The generative learning model(s) 144 can be useful for natural language processing, including receiving natural language prompts and providing natural language responses based on the text on which the model is trained.

The generative learning model(s) 144 takes as input the combined prompt from the predictive learning model(s) 140 and the custom user input query to create as output a list of recommendations to the user and/or create an itinerary for the user, as will be further described below.

Before implementation, the generative learning model(s) 144 will be trained on the training data sets 146. Training data sets 146 for LLMs such as the generative learning model(s) 144 may contain large, diverse collections of data, including: text, audio, imagery, and/or the like. This collection allows the model to learn patterns in the data and generate novel solutions that resemble the data on which it was trained. The quality, quantity, and variety of the training data sets 146 directly impacts the performance of the LLMs. For example, in order to train the generative learning model(s) 144 to be able to take as input a combined prompt of the user's custom input query and a list of their restaurant preferences (e.g., from a restaurant specific user analysis model), the generative learning model(s) 144 may be trained on training data sets 146 that contain information about different restaurants in the user's immediate area, what type of cuisine they serve, the atmosphere of the restaurant, etc. The more data the training data sets 146 can contain pertaining to information about restaurants, the generative learning model(s) 144 can generate a more personalized response to the user based on the prompt.

In some embodiments, the generative learning model(s) 144 can be a general purpose LLM, while the predictive learning model(s) 140 may be independently trained with the training data sets 142. For example, in such cases, the generative model may be a general purpose LLM previously trained on a large collection of data from sources other than travel-related data (e.g., an “off-the-shelf” LLM trained by a third party), but may then be fine-tuned based on travel-related training data to improve the ability of the LLM to provide accurate and personalized travel-related recommendations.

In some embodiments, the generative learning model(s) 144 can be trained (by the training data sets 146) and executed on the user device 110 via the client application 114. For example, the generative learning model(s) 144 can be configured to operate locally on the user device 110 to process input prompts and generate personalized travel recommendations without requiring extensive communication with the providing computing system 130. Alternatively, the generative learning model(s) 144 may be executed on the providing computing system 130, allowing for centralized processing and access to larger training data sets 146.

### II. Example Data Flow for a Hybrid AI Model (Also Referred to As a Hybrid AI System)

FIG. 2 is a block diagram of an example data flow 200 in which the hybrid AI system may operate, according to various aspects of the present disclosure. In some embodiments, the components illustrated in FIG. 2 are implemented by the providing computing system 130 described in FIG. 1. For example, the providing computing system 130 uses the processing circuit 132 to coordinate the flow of data between the user device 202, the case-specific user analysis models 204, the prompt generator 206, and the generative model 208. In some embodiments, the processing circuit 132 processes the user's custom input query received from the user device 202, retrieves user-specific data from the user data store 210 via the models 204, generates a hyper-personalized prompt using the prompt generator 206, and executes the generative model 208 to create output tailored to the query. The data flow 200 begins with a user device 202, which may correspond to the user device 110 described in FIG. 1. The user device may be a smartphone, tablet, or any other form of computing device. The user device 202 sends the user's custom input query (212) to case-specific user analysis models 204, which may correspond to certain predictive learning models 140 described in FIG. 1. In some embodiments, while not shown in FIG. 2, a trip-agnostic user analysis model may additionally be used in combination with a case-specific user analysis model 204, as discussed above with respect to FIG. 1. Depending on the user's request, a case-specific user analysis AI model 204 is chosen. For example, if the user's custom input query asks for a list of restaurant recommendations, a restaurant-specific user analysis AI model (a type of case-specific user analysis model 204) will be selected to respond to the user's query. The case-specific user analysis models 204 access the user data store 210 (which may correspond to the user data store 148 in FIG. 1) to retrieve user data (214) such as the user's recent dining preferences. In some embodiments, the user request may be a text prompt typed by the user or a spoken request received as audio data via a microphone. In other embodiments, the user's request may be the result of a user interface selection such as by selecting a button, link or other selectable user interface option that has been preconfigured to initiate a particular type of request (e.g., a button to generate restaurant recommendations or a travel itinerary). In the same example, the restaurant-specific user analysis AI model accesses the user data store 210 to access information about the user related to their restaurant preferences. As an example, the user data store 210 may contain information such as the ten most recent restaurants the user visited.

The case-specific user analysis models 204 (which may correspond to certain predictive learning model(s) 140 as described in FIG. 1) then outputs personalized preferences (also referred to as predictive model outputs or intermediate outputs as described in connection with FIG. 1) 216 to a prompt generator 206 (which may correspond to the prompt generator 150 in FIG. 1) based on the user's custom input and the user data from the user data store 210. For example, based on the user's custom query asking for restaurant recommendations and the user data indicating that the user has chosen restaurants specializing in Italian cuisine on their four most recent visits, the case-specific user analysis model 204 will output that the user prefers Italian cuisine. This output (216) is then sent to the prompt generator 206 to create a hyper-personalized prompt for the generative model 208. The personalized preferences generated by the case-specific user analysis models 204 may include narrative text, structured data, or embeddings, depending on the model type and the use case.

Additionally or alternatively, multiple case-specific user analysis models 204 (also referred to as predictive learning model(s) 140 as described in FIG. 1) could create a more elaborate prompt for a generative model 208, which corresponds to the generative learning model(s) described in FIG. 1, to create an itinerary. For example, the relevant information for a restaurant recommendation use case may also include user profile information and/or other history that the user has with a travel service or similar other platform that is not specific to restaurants but may nonetheless be relevant to generate personalized restaurant recommendations. In such cases, the trip-agnostic user analysis model may access the user data store 210 to retrieve general personalized information (214). For example, data may be retrieved by the trip-agnostic user analysis model to help to infer the number of people likely joining the user for the desired meal (e.g., based on the number of people included in a hotel reservation or who booked flights to the relevant city, inferred family size, etc.), cuisine type preferences and price preferences, etc. In this example, based on the user's custom query asking for restaurant recommendations and the user data showing that the user's young children are on the trip, the case-specific user analysis model 204 will output that the user is looking for family friendly restaurants.

As shown in FIG. 2, multiple case-specific user analysis models 204, which are part of the predictive learning models 140 described in FIG. 1, may operate independently to generate separate outputs 216 based on the user's preferences and query. For example, a restaurant-specific user analysis AI model and an activity-specific user analysis AI model, both of which are types of case-specific user analysis models 204, may analyze user data from the user data store 210 to generate separate outputs (e.g., could run separately to produce separate input prompts detailing the user's restaurant and activity preferences). These two input prompts could be combined with the input prompt from the trip-agnostic user analysis model discussed above and the custom user input query 222 to create a more elaborate prompt. The elaborate input prompt can assist the generative model 208 (also referred to as a generative AI model) in creating an itinerary.

In some embodiments, the case-specific user analysis models 204 may run in batch processes offline (e.g., when new data is added to the user data store 210). In this example, the case-specific user analysis models 204 may store their output prompts 216 containing user preference details to be used later (e.g., when the user sends a custom input query). This embodiment saves computer processing power as it does not require running the case-specific user analysis models 204 for every request.

The output from the case-specific user analysis models 204 may be in the form of human readable text, such as, “The user prefers Italian cuisine.” Alternatively, the output from the case-specific user analysis models 204 may be in the form of computer-readable embeddings. For example, the embeddings may be in an embedding space that was previously learned and optionally jointly trained with the LLM, such that the embeddings are in a form that, while not meaningful to a human, provides personalization context to the LLM and can be combined with a traditional LLM prompt written in English (e.g., the embedding may be passed to the LLM as a supplemental input in addition to a user-written prompt in a given instance).

The prompt generator 206 takes as input the case-specific user analysis models 204 outputs 216 and the user's custom input query 222 and combines them in such a way as to create a prompt 218 readable by a generative AI model (such as the generative model 208). For example, the prompt generator 206 may combine outputs from the restaurant-specific user analysis model (a type of case-specific user analysis model 204) indicating that the user prefers Italian cuisine and family-friendly restaurants, with the user's custom input query, such as “Please show me a list of restaurant recommendations.” The resulting prompt 218 may read, “Please show me a list of restaurants that are family-friendly and specialize in Italian cuisine.” The resulting prompt is then sent to the generative model 208 to generate personalized recommendations based on the user's preferences and query.

The prompt created by the prompt generator 206 may be in the form of human readable text, such as, “Please show me a list of restaurants that are family friendly and specialize in Italian cuisine.” Alternatively, the output from the case-specific user analysis model 204 may be in the form of computer readable embeddings.

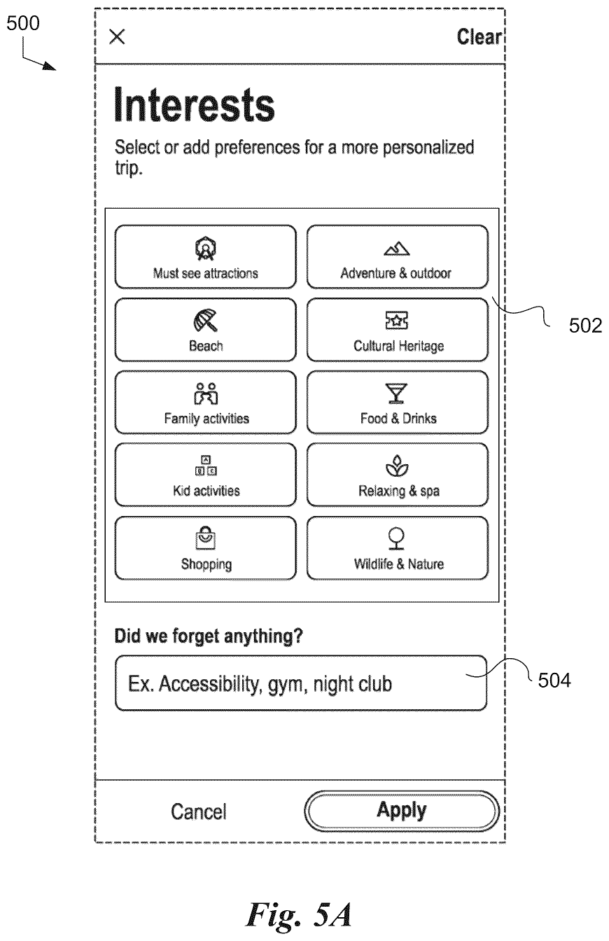

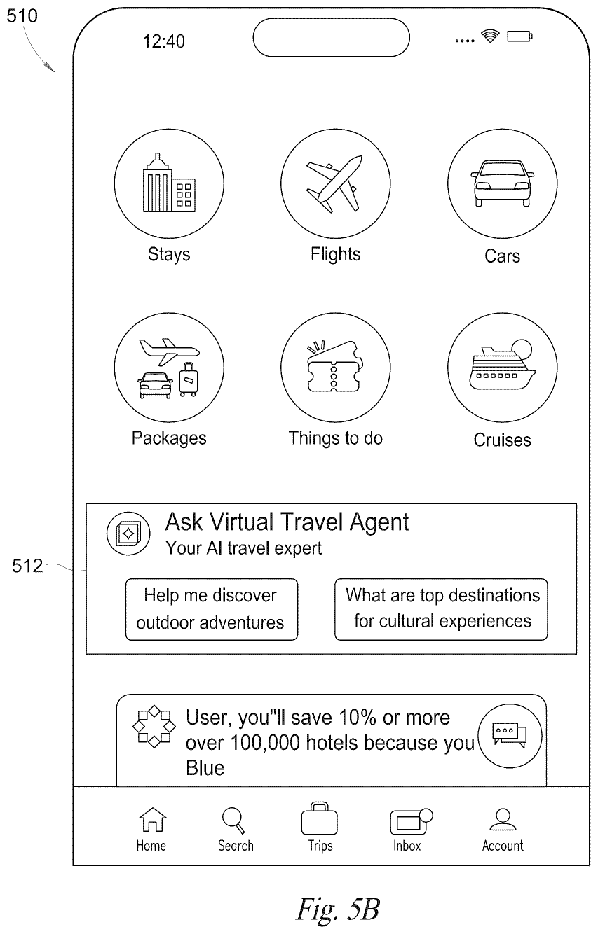

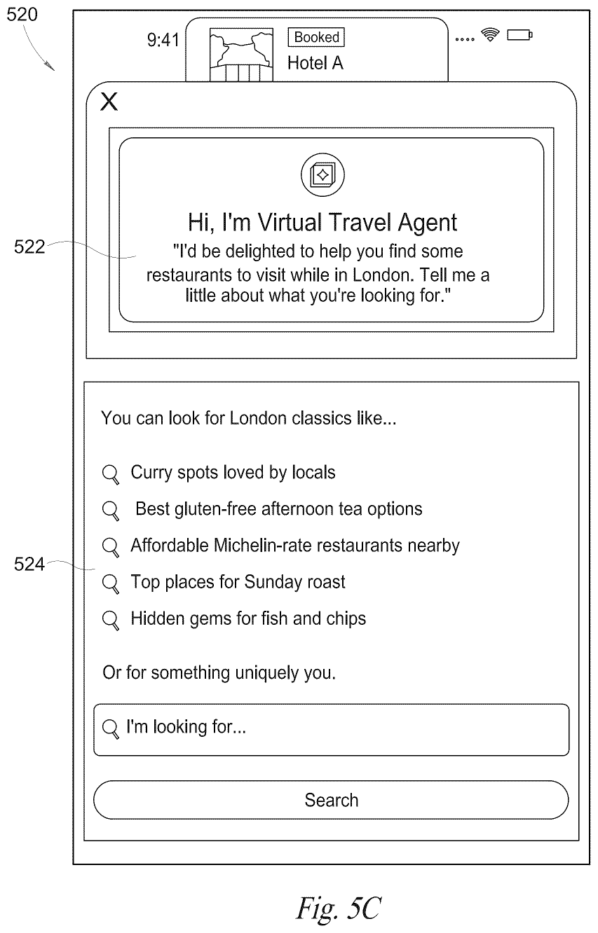

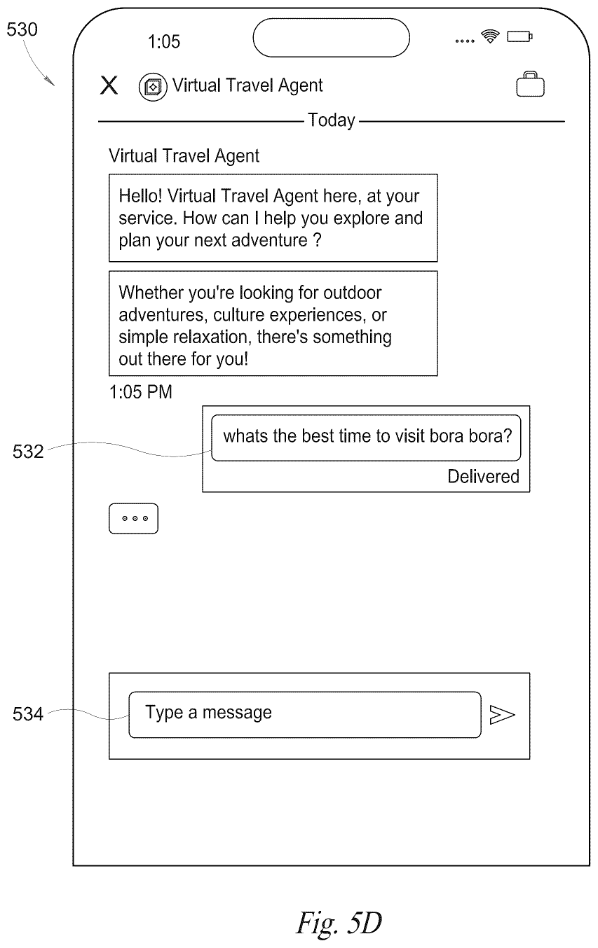

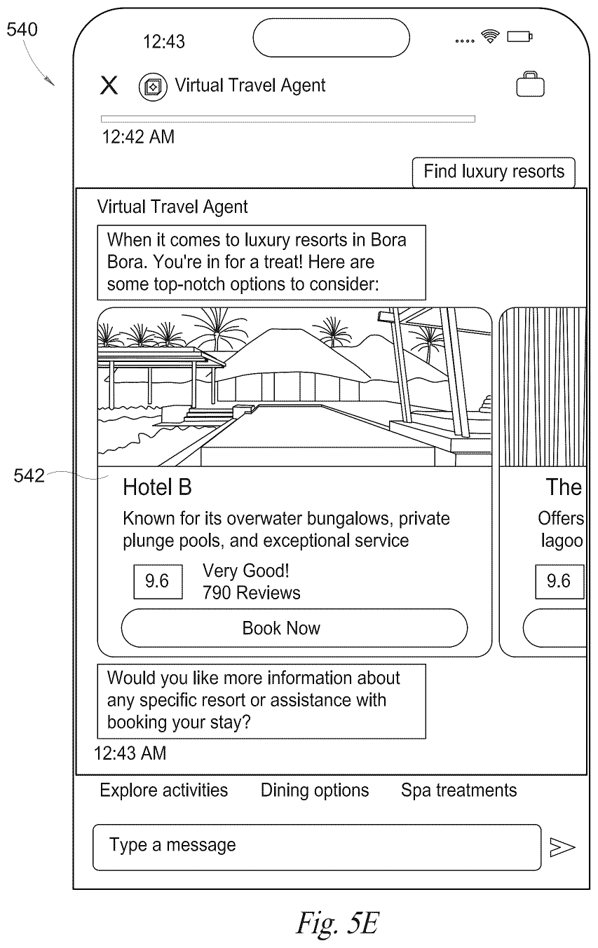

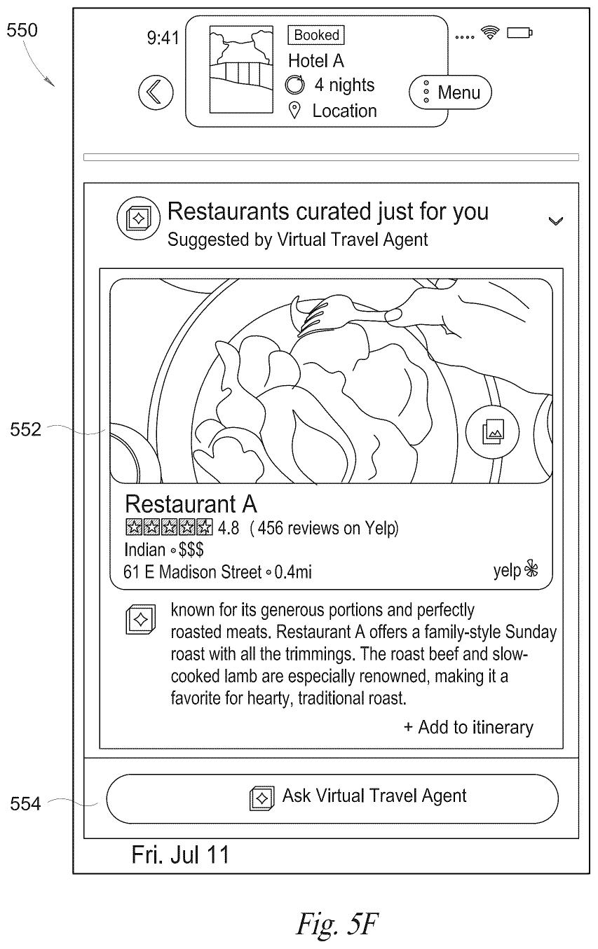

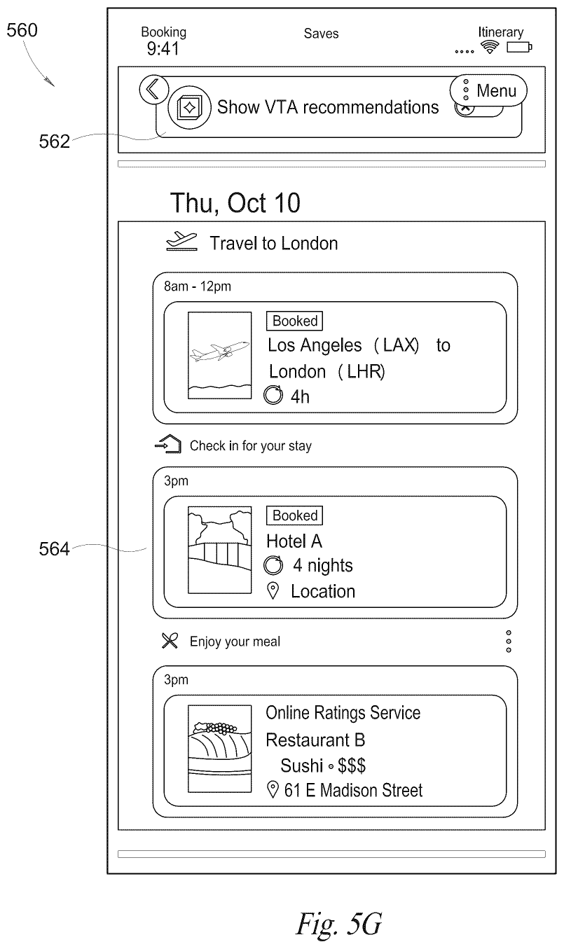

The generative model 208 takes as input the prompt 218 generated from the prompt generator 206 and outputs a list of recommendations personalized to the user. Based on the above example, if the generative model 208 took as input the prompt, “Please show me a list of restaurants that are family friendly and specialize in Italian cuisine,” the generative model 208 will output a list of restaurant recommendations in the area that specialize in Italian cuisine and are family friendly. The generative model 208 may then provide this list of travel recommendations to the user device 202, which corresponds to the user device 110 described in FIG. 1, for display via the client application 114 (as described in FIG. 1) for selection. Additionally or alternatively, the generative model 208 may provide travel recommendations 220 to the user device 202 in the form of an itinerary, as described below in FIG. 5G.

The custom user input query may request an itinerary to be built using the hybrid AI system. In this case, the case-specific user analysis models 204 may use multiple case-specific user analysis models, such as the restaurant-specific user analysis model and the activity-specific user analysis AI model, to create multiple detailed prompts to input to the generative model 208. Additionally or alternatively, the generative model 208 may create the itinerary without the use of a more specific prompt from multiple case-specific user analysis models 204.

Additionally, after the user selects a travel recommendation from the list provided by the generative model 208 (which corresponds to the generative learning model(s) 144 as described in FIG. 1), the user selection will be added to the user data store 210 as further preference data about the user. For example, once the user selects a restaurant from the list of restaurant recommendations provided by the generative model 208, the user data store 210 will store information such as the restaurant the user chose, the type of cuisine they offer, the restaurant's distance to the user's current hotel, etc. This information will then be reused by the predictive learning model(s) 140, as described in FIG. 1, to refine future recommendations. In subsequent queries, the case-specific user analysis models 204 may access the stored data to generate personalized outputs. For example, if the user repeatedly selects Italian restaurants, the system may prioritize Italian cuisine in future restaurant recommendations.

### III. Example Restaurant Recommendation by Hybrid AI System

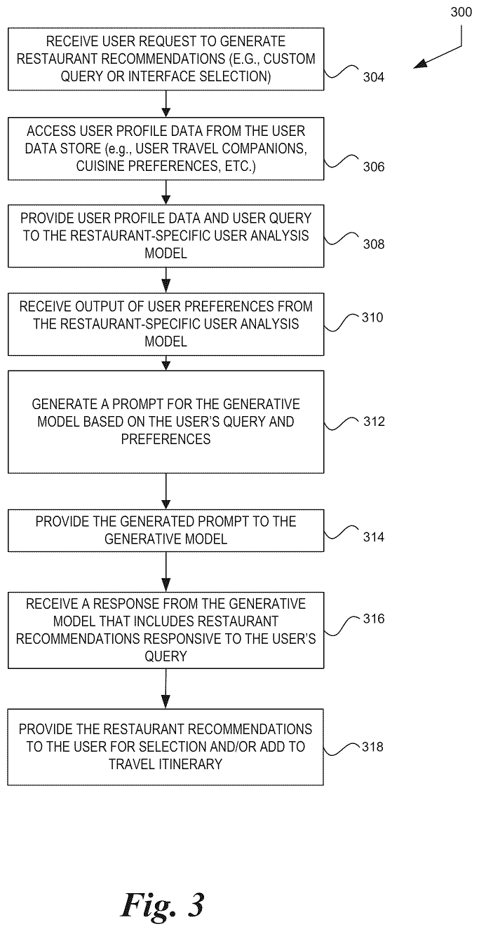

FIG. 3 is a flow diagram showing an example routine 300 for generating a restaurant recommendation (e.g., as performed by the providing computing system 130), according to various aspects of the present disclosure.

At block 304, a request to generate restaurant recommendations is received via the client application 114 on the user device 110, as described in FIG. 1. The request may be in the form of a custom user input query, such as “Please provide me with local restaurants,” “Good restaurants in Bora Bora,” or “Create a dinner itinerary for me during my vacation in Bora Bora.” Alternatively, the request may be initiated through a user interface selection, such as clicking a button or link preconfigured to request restaurant recommendations. The request is transmitted to the providing computing system 130, which begins processing the user's input.

At block 306, the providing computing system 130 accesses user profile data from the user data store 148, as described in FIG. 1. The user profile data may include explicit preferences, such as favorite cuisines, travel companions, and budget, as well as inferred preferences based on prior interactions, such as the types of restaurants the user has previously selected or visited. This data is retrieved to provide context for generating personalized recommendations. For example, if the user has previously selected Italian restaurants, this preference may be retrieved and used to refine the output.

At block 308, the user profile data and the user's query are provided to the restaurant-specific user analysis model, which is a type of case-specific user analysis model 204 described in FIG. 2. The restaurant-specific user analysis model analyzes the user's preferences and query to generate outputs tailored to the user's request. For example, the model may determine that the user prefers Italian cuisine, family-friendly restaurants, and locations within walking distance of their hotel. In some cases, additional general travel information, such as the user's willingness to travel a certain distance, may be provided by the trip-agnostic user analysis model, as described in FIG. 1.

At block 310, the restaurant-specific user analysis model outputs a prompt containing the user's restaurant preferences. This prompt may include narrative text, such as “The user prefers Italian cuisine and family-friendly restaurants within five minutes of their hotel,” or computer-readable embeddings that encode the same information. These outputs are then passed to the prompt generator 206 for further processing.

At block 312, the prompt generator 206 generates a prompt for the generative model 208 based on the user's query and preferences. The prompt combines the user's custom input query with the outputs from the restaurant-specific user analysis model and, if applicable, the trip-agnostic user analysis model. For example, the prompt may read, “Generate a list of Italian restaurants that are family-friendly and within five minutes of my hotel.” In some embodiments, the prompt is provided to the generative model 208 in the form of human-readable text, while in other embodiments, it may include computer-readable embeddings.

At block 314, the prompt generator 206 provides the generated prompt to the generative model 208 as input. The generative model 208 processes the prompt and begins generating personalized restaurant recommendations tailored to the user's preferences and query.

At block 316, the providing computing system 130 receives a response from the generative model 208 that includes restaurant recommendations responsive to the user's query. For example, if the user requested information about local restaurants and the restaurant-specific user analysis model output indicated a preference for family-friendly Italian restaurants, the generative model 208 may generate a list of restaurants that meet these criteria. The recommendations may include details such as restaurant names, cuisine types, locations, and user reviews.

At block 318, the providing computing system 130 sends the personalized restaurant recommendations to the user device 110 via the client application 114, as described in FIG. 1. The recommendations are displayed to the user, allowing them to select or add a restaurant to their travel itinerary. In some embodiments, the recommendations may also include options to book reservations directly through the client application.

### IV. Example Activity Recommendations From Hybrid AI System

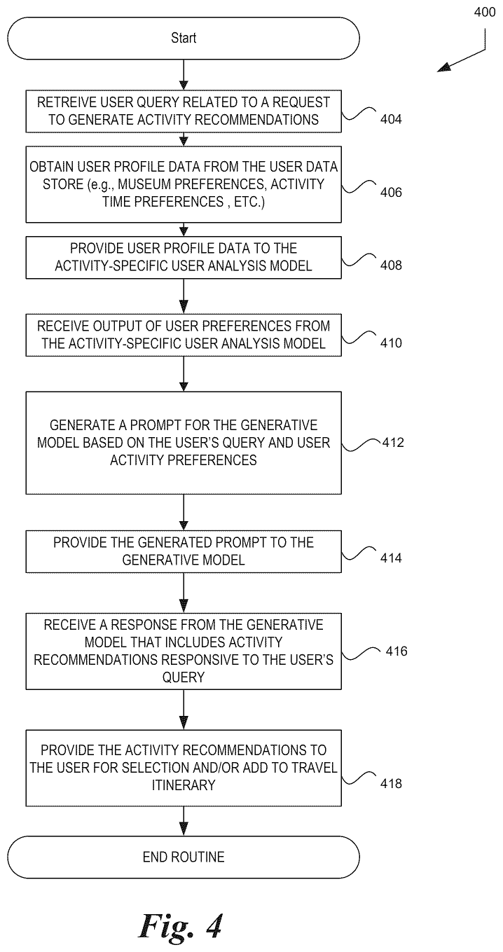

FIG. 4 is a flow diagram showing an example routine 400 of an activity recommendation (e.g., as performed by the providing computing system 130), according to various aspects of the present disclosure.

At block 404, a request to generate activity recommendations is received. In some embodiments, the request may be in the form of a custom user input query such as, “please provide me with local museums,” “best tours in Bora Bora,” or “create an itinerary for me during my vacation in Bora Bora.” Alternatively, the request may be initiated through a user interface selection, such as clicking a button or link preconfigured to request activity recommendations. The request is transmitted to the providing computing system 130, which begins processing the user's input.

At block 406, as previously described in FIG. 3, user profile data may be obtained from the user data store 148. In some embodiments, the user profile data may contain information such as the user's museum companions, activity type preferences (e.g., adventurous, cultural, wildlife, etc.), etc. It will be appreciated that the relevant types of data that are retrieved or accessed at block 406 may have been learned through a model training process to determine the types of personalization context that resulted in the best activity recommendations or more accurate personalization of the ultimate LLM output during training. For example, if the user has previously selected cultural activities, this preference may be retrieved and used to refine the output.

At block 408, the user profile data and the user's query are provided to the activity-specific user analysis model. The activity-specific user analysis model analyzes the user's preferences and query to generate outputs tailored to the user's request. For example, the model may determine that the user prefers cultural activities, locations within walking distance of their hotel, and activities available in the morning. In some cases, additional general travel information, such as the user's willingness to travel a certain distance, may be provided by the trip-agnostic user analysis model, as described in FIG. 1.

At block 410, the activity-specific user analysis model and/or the trip-agnostic user analysis model of the predictive learning model(s) 140 outputs a prompt (or partial prompt to be supplemented below) and/or embedding containing or representing user activity preferences. The activity preferences may include information such as types of activities the user likes, how far away from the user's hotel they are willing to travel, what time of day the user prefers to do the activity, etc. These outputs are then passed to the prompt generator 206 for further processing, as described in FIG. 2.

At block 412, the prompt generator 206 generates a prompt to be input to the generative model 208 based on the user's query and preferences. The prompt combines the user's custom input query with the outputs from the activity-specific user analysis model and, if applicable, the trip-agnostic user analysis model. For example, the prompt may read, “Generate a list of cultural activities that are available in the morning and within five minutes of my hotel.” In some embodiments, the prompt is provided to the generative model 208 in the form of human-readable text, while in other embodiments, it may include computer-readable embeddings.

At block 414, the prompt generator 206 provides the generated prompt to the generative model 208 as input. The generative model 208 processes the prompt and begins generating personalized activity recommendations tailored to the user's preferences and query.

At block 416, the providing computing system 130 receives a response from the generative model 208 that includes activity recommendations that are within the personalized confines of the user's query. For example, if the user requested information about local museums (combined with the activity specific analytical AI model output that the user wants to be able to tour the museum at 7 AM), the generative model 208 generates and provides to the providing computing system 130 a list of museums that are open early.

At block 418, the providing computing system 130 sends the personalized activity recommendations to the user device 110 via the client application 114, as described in FIG. 1. The recommendations are displayed to the user, allowing them to select or add an activity to their travel itinerary. In some embodiments, the recommendations may also include options to book activities directly through the client application.

### V. Example User Interfaces for Client Application Utilizing the Hybrid AI System

FIGS. 5A-5G are example user interfaces of the hybrid AI system on the client application 114, according to various aspects of the present disclosure. In some embodiments, the user interfaces may be generated at least in part by the providing computing system 130 and sent to the user device for display in the client application 114 (such as an application created by a travel service) or a general-purpose browser application, for example. The user interfaces can be used to facilitate interaction between the user and the hybrid AI system, enabling the user to input preferences, submit queries, and receive personalized recommendations generated by the predictive learning model(s) 140 and the generative learning model(s) 144, as described in FIGS. 1-4. In other embodiments, the user interfaces may be generated on the client device based in part on data received from the providing computing system 130.

FIG. 5A illustrates an example travel profile user interface 500. Illustrated in the travel profile user interface 500 are a list of travel preferences 502, and a custom preference text box 504. The travel profile user interface 500 allows the user to input their restaurant, activity, and/or other travel related preferences to the client application 114. The providing computing system 130 can then gather this data provided by the user to store in the user data store 148. For example, the user may select “Family activities” and “Food & Drinks” from the list of travel preferences 502. The user may also choose to include “Italian food” in the custom preference text box 504 and hit Apply. This data is then accessible to the predictive learning models 140, which use it to generate personalized outputs, as described in FIG. 1. The providing computing system 130 will then store in the user data store 148 that the user is travelling with their family, prefers Italian cuisine, and is looking for restaurants during their trip. In some embodiments, the user may have created the travel profile through a UI the same as or similar to the travel profile user interface 500 prior to using the hybrid AI model (also referred to as the hybrid AI system). When the user then proceeds to utilize the hybrid AI model, the predictive learning models 140 will access the user's preferences that they provided to the travel profile user interface 500 (via the user data store 148) to create a more personalized prompt for the generative model 208.

FIG. 5B illustrates an example application screen 510. The example application screen 510 includes an illustration of an AI prompt 512. The AI prompt 512 displays to the user the hybrid AI model's ability to “help [the user] discover outdoor adventures,” and shows an example custom user input query “What are top destinations for cultural experiences?” In some embodiments, the AI prompt 512 can be displayed on the example application screen 510, and/or on any other screen within the client application 114 to prompt the user to utilize the hybrid AI model. For example, in an instance where the client application 114 is presenting to the user a list of French Polynesian travel destinations, the AI prompt 512 can be displayed at the bottom of the UI as shown in the example application screen 510 to prompt the user to receive personalized trave recommendations about a vacation to Bora Bora.

The AI prompt 512 may further include a general assistant agent (which may be referenced in a user interface as a virtual travel agent). The general assistant agent may assist the user in the general beginning phases of creating the travel profile (e.g., such as travel profile user interface 500). For example, as illustrated in FIG. 5A, the user may select one or more travel preferences from the list of travel preferences 502. The general assistant agent can be utilized to store the users selected travel preferences in the user data store 148. The stored travel preferences can then be accessed by the predictive learning model(s) 140 to generate personalized prompts for the generative learning model(s) 144, as described in FIG. 1. The stored travel preferences can be later accessed by more specialized agents to generate more personalized recommendations to the user, as described in more detail herein.

FIG. 5C illustrates an example input screen 520 for a user after selecting the AI prompt 512 shown in FIG. 5B. The input screen 520 may include an introduction to the general AI agent 522 to the user, and a list of example inputs 524. The introduction to the general AI agent 522 may include a small introductory paragraph, followed by a prompt to the user to explain how to utilize the agent. For example, as illustrated in the example input screen 520, the general AI agent 522 may write “I'd be delighted to help you find some restaurants to visit while in London.” This introduction may prompt the user to the functionality of the hybrid AI model, and/or hint to the user as to how to utilize the hybrid AI model. The list of example inputs 524 functions similarly to the travel profile user interface 500 as described in FIG. 5A above.

FIGS. 5D and 5E illustrate example instances of users communicating with the hybrid AI model. As an example, chat example 530 illustrates a user entering their custom input query 532. The user may enter their custom input query 532 using the chat box 534. As illustrated, the general AI agent 522 may begin the conversation by introduction itself to the user and offering examples of its services that the user can utilize. The user may then choose to type in their custom input query 532, as illustrated in chat example 530. The hybrid AI system processes the user's query by combining it with personalized outputs from the case-specific user analysis models, as described in FIG. 2, to generate a prompt for the generative model 208.

As another example, chat example 540 shows the hybrid AI model's output 542. In some embodiments, the output 542 may be presented to the user in the form of a listing of recommendations based on a hidden prompt generated by the user's custom input query 532 and the personalization output from the plurality of predictive learning models 140, as described in FIG. 2. For example, specialized agents (e.g., restaurant agents, activity agents, etc.,) may access the data stored (via the general AI agent 522) to determine the user's travel preferences. The specialized agents may then provide the user travel preferences to the hybrid AI model to receive travel recommendations personalized to the user. The output 542 may include an introductory passage recognizing the user's input, a conclusion paragraph to continue the conversation with the user, and the listing of recommendations. The listing of recommendations can include information pertaining to the listing, such as the title, a brief description, and the listings review rating.

The output 542 may also include a “Book Now” button. This button would allow the user to add the listing to their itinerary and/or travel plans via the client application 114. In some embodiments, the output 542 may be in the form of a created itinerary for the user. In this example, the user may have requested for an itinerary to be created based on their custom input.

FIG. 5F illustrates an example listing recommendation 550 from the hybrid AI model. The listing recommendation 550 includes the output 552 and an AI selector 554. The output 552 functions similar to or the same as the output 542 from the chat example 540. In some embodiments, the output 552 may include the restaurant recommendation, a brief description of the restaurant, the review ratings of the restaurant, and/or an option to add the restaurant to the user's itinerary. The output 552 may also include multiple options for the user to choose between by scrolling in the client application 114. The AI selector 554 allows the user to access the chat example 540 as described in FIGS. 5D and 5E above.

FIG. 5G shows an example itinerary UI 560 created by the hybrid AI model. The itinerary UI 560 may include an option to show AI recommendations 562 and the user's itinerary 564. The itinerary UI 560 can be created in addition to or alternatively to the example listing recommendation 550 described above in FIG. 5F.

The AI recommendations 562 may provide a user an option to show recommendations from the hybrid AI model for more activities/restaurants that would fit their current itinerary generated by the specialized agents. For example, if the user is staying at “Hotel A” and having dinner at “Endo at The Rotunda,” by turning on AI recommendations 562, the activity specialized agent may access the user preferences to generate recommendations for the user that they may enjoy that are located between the “Hotel A” and “Restaurant B,” the UI may then display the activity recommendations to the user. Hotel A

The user's itinerary 564 may be created as output from the hybrid AI model. For example, if the user's custom input query asked for an itinerary to be made for their trip to London, the hybrid AI model might output the itinerary shown in FIG. 5G.

### VI. Example Computing Device

FIG. 6 illustrates an example computing device 600 configured to execute the processes and implement the features described above. The computing device 600 may include: a processing unit 602 (e.g., computer processor), such as a physical central processing unit (“CPU”); a network interface 604, such as a network interface card (“NICs”); a computer readable medium drive 606, such as a high density disk (“HDD”), a solid state drive (“SDD”), a flash drive, and/or other persistent non-transitory computer-readable media; an I/O device interface 608, such as an I/O interface in communication with one or more microphones; and a memory 610 (e.g., a computer readable memory), such as random access memory (“RAM”) and/or other volatile non-transitory computer-readable media. The example computing device 600 may correspond to the providing computing system 130 of FIG. 1. Specifically, the processing unit 602 may execute the hybrid AI system described in connection with FIG. 1, wherein the memory 610 stores the predictive model(s) 140 and the generative learning model(s) 144. The memory 610 may also store training datasets 142 and 146. The network interface 604 allows the computing device 600 to connect to the user device 110 and third-party systems 104 over the network 102.

The network interface 604 can provide connectivity to one or more networks or computing systems, the processing unit 602 can receive information and instructions from other computing systems or services via the network interface 604. The network interface 604 can also store data directly to the memory 610, etc.

The memory 610 may include computer program instructions that the processing unit 602 executes in order to implement one or more embodiments. The memory 610 can store an operating system 612 that provides computer program instructions for use by the processing unit 602 in the general administration and operation of the computing device 600. The memory 610 can further include computer program instructions and other information for implementing aspects of the present disclosure. For example, in one embodiment, the memory 610 may include a user interface module 614 (e.g., for displaying the output 542, the output 552, and/or the user's itinerary 564 as referred to herein). As another example, the memory 610 may include generative AI components 616 and/or predictive AI components 618. The generative AI components 616 and/or AI components 618 allow the computing device 600 to utilize the hybrid AI model as described in FIG. 2 above.

### VII. Additional Implementation Details, Terminology, and Aspects

To facilitate an understanding of the systems and methods discussed herein, several terms are described below. These terms, as well as other terms used herein, should be construed to include the provided descriptions, the ordinary and customary meanings of the terms, and/or any other implied meaning for the respective terms, wherein such construction is consistent with context of the term. Thus, the descriptions below do not limit the meaning of these terms, but only provide example descriptions.

As noted above, the term “model” or AI model,” as used in the present disclosure, can include any computer-based models of any type and of any level of complexity, such as any type of sequential, functional, or concurrent model. A language model is any algorithm, rule, model, and/or other programmatic instructions that can predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language responses based on the text on which the model is trained. A language model may include an n-gram, exponential, positional, neural network, and/or other type of model.

A Large Language Model (“LLM”) is any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. An LLM may comprise a NN trained using self-supervised learning. An LLM may be of any type, including a Question Answer (“QA”) LLM that may be optimized for generating answers from a context, a multimodal LLM/model, and/or the like. An LLM (and/or other models of the present disclosure), may include, for example, attention-based and/or transformer architecture or functionality.

While certain aspects and implementations are discussed herein with reference to use of a language model, LLM, and/or AI model, those aspects and implementations may be performed by any other language model, LLM, AI model, generative AI model, generative model, ML model, NN, multimodal model, and/or other algorithmic processes. Similarly, while certain aspects and implementations are discussed herein with reference to use of a ML model, those aspects and implementations may be performed by any other AI model, generative AI model, generative model, NN, multimodal model, and/or other algorithmic processes.

In various implementations, the LLMs and/or other models (including ML models) of the present disclosure may be locally hosted, cloud managed, accessed via one or more Application Programming Interfaces (“APIs”), and/or any combination of the foregoing and/or the like. Additionally, in various implementations, the LLMs and/or other models (including ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Examples of models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLaMA (Large Language Model Meta AI), and BigScience Large Open-science Open-access Multilingual Language Model (BLOOM).

Although the terms machine learning and/or artificial intelligence are used herein, the scope of each term shall include each and every type of machine learning, artificial intelligence, neural network, and the like, known to a person of ordinary skill in the art. An AI model can be built or trained based on sample data or training data in order to make predictions or decisions without being explicitly programmed to do so. In some embodiments, machine learning algorithms, models, and/or programs can perform tasks without being explicitly programmed to do so. For example, some aspects of the present disclosure may include training an AI model in a computer to carry out certain desired tasks that a human may not be able to perform manually.

A number of different types of AI algorithms and AI models or approaches may be used by a machine learning component to implement the models. For example, certain embodiments herein may use a logistical regression model, decision trees, random forests, convolutional neural networks, deep networks, or others. However, other models are possible, such as a linear regression model, a discrete choice model, or a generalized linear model. The machine learning aspects can be configured to adaptively develop and update the models over time based on new input. For example, the models can be trained, retrained, or otherwise updated on a periodic basis as new received data is available to help keep the predictions in the model more accurate as the data is collected over time. Also, for example, the models can be trained, retrained, or otherwise updated based on configurations received from a user, admin, or other devices. Some non-limiting examples of machine learning algorithms that can be used to train, retrain, or otherwise update the models can include supervised and non-supervised machine learning algorithms, including regression algorithms (such as, for example, Ordinary Least Squares Regression), instance-based algorithms (such as, for example, Learning Vector Quantization), decision tree algorithms (such as, for example, classification and regression trees), Bayesian algorithms (such as, for example, Naive Bayes), clustering algorithms (such as, for example, k-means clustering), association rule learning algorithms (such as, for example, Apriori algorithms), artificial neural network algorithms (such as, for example, Perceptron), deep learning algorithms (such as, for example, Deep Boltzmann Machine), dimensionality reduction algorithms (such as, for example, Principal Component Analysis), ensemble algorithms (such as, for example, Stacked Generalization), support-vector machines, federated learning, and/or other machine learning algorithm. These machine learning algorithms may include any type of machine learning algorithm including hierarchical clustering algorithms and cluster analysis algorithms, such as a k-means algorithm. In some cases, the performing of the machine learning algorithms may include the use of an artificial neural network. By using machine-learning techniques, large amounts (such as terabytes or petabytes) of received data may be analyzed to generate or implement models with minimal, or with no, manual analysis or review by one or more people.

In some embodiments, supervised learning algorithms can build a mathematical model of a set of data that contains both the inputs and the desired outputs. For example, training data can be used, which comprises a set of training or labeled/annotated examples. Each training example has one or more inputs and the desired output, also known as a supervisory signal. In the mathematical model, for example, each training example is represented by an array or vector (e.g., a feature vector), and the training data is represented by a matrix. Through iterative optimization of an objective function, supervised learning algorithms can learn a function that can be used to predict the output associated with new inputs. An optimal function, for example, can allow the algorithm to correctly determine the output for inputs that were not a part of the training data. For instance, an algorithm that improves the accuracy of its outputs or predictions over time is said to have learned to perform that task. Types of supervised-learning algorithms may include, but are not limited to active learning, classification, and regression. Classification algorithms, for example, are used when the outputs are restricted to a limited set of values. Regression algorithms, for example, are used when the outputs may have any numerical value within a range. As an example, for a classification algorithm that filters emails, the input would be an incoming email, and the output would be the name of the folder in which to file the email. In some embodiments, similarity learning, an area of supervised machine learning, is closely related to regression and classification, but the goal is to learn from examples using a similarity function that measures how similar or related two objects are. In some embodiments, similarity learning has applications in ranking, recommendation systems, visual identity tracking, face verification, and speaker verification.

In some embodiments, unsupervised learning algorithms can take a set of data that contains only inputs, and find structure in the data, like grouping or clustering of data points. For example, the algorithms can learn from test data that has not been labeled, classified, or categorized. Instead of responding to feedback, unsupervised learning algorithms can identify commonalities in the data and react based on the presence or absence of such commonalities in each new piece of data. In some embodiments, unsupervised learning encompasses summarizing and explaining data features. In some embodiments, cluster analysis is the assignment of a set of observations into subsets (e.g., clusters) so that observations within the same cluster are similar according to one or more predesignated criteria, while observations drawn from different clusters are dissimilar. In some cases, different clustering techniques can make different assumptions on the structure of the data, often defined by some similarity metric and evaluated, for example, by internal compactness, or the similarity between members of the same cluster, and separation, the difference between clusters. Other methods, for example, can be based on estimated density and graph connectivity.

In some embodiments, semi-supervised learning can be a combination of unsupervised learning (without any labeled training data) and supervised learning (with completely labeled training data). For example, some of the training examples may be missing training labels, and in some cases such training examples can produce a considerable improvement in learning accuracy as compared to supervised learning. In some embodiments, and in weakly supervised learning, the training labels can be noisy, limited, or imprecise; however, these labels are often cheaper to obtain, resulting in larger effective training sets.

In some embodiments, an area of machine learning is concerned with how software agents ought to take actions in an environment so as to maximize some notion of cumulative reward. In some embodiments, the environment is typically represented as a Markov decision process (MDP). In some embodiments, reinforcement learning algorithms use dynamic programming techniques. In some embodiments, reinforcement learning algorithms do not assume knowledge of an exact mathematical model of the MDP and are used when exact models are infeasible.

In addition to supervised learning algorithms, unsupervised learning algorithms, and semi-supervised learning, and in some embodiments, other types of machine learning methods can be implemented, such as: reinforcement learning (e.g., how software agents ought to take actions in an environment so as to maximize some notion of cumulative reward); dimensionality reduction (e.g., process of reducing the number of random variables under consideration by obtaining a set of principal variables); self-learning (e.g., learning with no external rewards and no external teacher advice); feature learning or representation learning (e.g., preserve information in their input but also transform it in a way that makes it useful); anomaly detection or outlier detection (e.g., identification of rare items, events or observations which raise suspicions by differing significantly from the majority of the data); association rules (e.g., discovering relationships between variables in large databases); and/or the like.

Additionally, depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design conditions imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Further, according to various embodiments, various interactive graphical user interfaces can be provided for allowing various types of users to interact with the systems and methods described herein to, for example, generate, review, and/or modify data captured by or used by one or more of the disclosed systems or methods.

The interactive and dynamic user interfaces described herein are enabled by innovations in efficient interactions between the user interfaces and underlying systems and components. For example, disclosed herein are improved methods of receiving user inputs, translation and delivery of those inputs to various system components, automatic and dynamic execution of complex processes in response to the input delivery, automatic interaction among various components and processes of the system, and automatic and dynamic updating of the user interfaces. The interactions and presentation of data via the interactive user interfaces described herein may accordingly provide cognitive and ergonomic efficiencies and advantages over previous systems.

Accordingly, in various embodiments, large amounts of data may be automatically and dynamically gathered and analyzed in response to user inputs and configurations, and the analyzed data may be efficiently presented to users. Thus, in some embodiments, the systems, devices, configuration capabilities, graphical user interfaces, and the like described herein are more efficient as compared to previous systems, and/or the like.

Various embodiments of the present disclosure provide improvements to various technologies and technological fields, and practical applications of various technological features and advancements. For example, as described above, some existing systems are limited in various ways, and various embodiments of the present disclosure provide significant improvements over such systems, and practical applications of such improvements. Additionally, various embodiments of the present disclosure are inextricably tied to and provide practical applications of computer technology. In particular, various embodiments rely on specialized hardware installed in specific locations as well as software components to improve energy and processing efficiency. Such features and others are intimately tied to, and enabled by, computer technology, artificial intelligence, and digital signal technology and would not exist except for computer technology, artificial intelligence, and digital signal technology. For example, the review analysis system, embedding system, and search system cannot reasonably be performed by humans alone, without the computer and technology upon which they are implemented. Further, the implementation of the various embodiments of the present disclosure via computer technology enables many of the advantages described herein, including more efficient interaction with, and analysis of, various types of electronic data, and the like.

Various combinations of the above recited features, embodiments, and aspects are also disclosed and contemplated by the present disclosure. Additional embodiments of the disclosure are described below in reference to the appended claims, which may serve as an additional summary of the disclosure.

In various embodiments, systems and/or computer systems are disclosed that comprise a computer-readable storage medium having program instructions embodied therewith, and one or more processors configured to execute the program instructions to cause the systems and/or computer systems to perform operations comprising one or more aspects of the above-and/or below-described embodiments (including one or more aspects of the appended claims).

In various embodiments, computer-implemented methods are disclosed in which, by one or more processors executing program instructions, one or more aspects of the above-and/or below-described embodiments (including one or more aspects of the appended claims) are implemented and/or performed.

In various embodiments, computer program products comprising a computer-readable storage medium are disclosed, wherein the computer-readable storage medium has program instructions embodied therewith, the program instructions executable by one or more processors to cause the one or more processors to perform operations comprising one or more aspects of the above-and/or below-described embodiments (including one or more aspects of the appended claims).

Although certain preferred embodiments and examples are disclosed above, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. Unless otherwise explicitly stated, the terms “set” and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A computer-implemented method comprising:
receiving, from a computing device associated with a user, a user query to generate a travel recommendation;
accessing, from a user information data store, at least one of user profile data;
determining, with an analytical model, a user travel preference based at least in part on the user profile data;
generating, with a prompt generator, a hyper-personalized prompt for a generative AI model, wherein the hyper-personalized prompt is generated based at least in part on an output of the analytical model and the user query;
generating, with the generative AI model, a personalized travel recommendation based at least in part on the hyper-personalized prompt; and
providing the personalized travel recommendation to the computing device.

2. The computer-implemented method of claim 1, further comprising:
selecting, with the analytical model, a case-specific user analysis model from a plurality of trained models, wherein the selection is based at least in part on a particular type of travel recommendation requested in the user query; and
determining, with the selected case-specific user analysis model, a refined user travel preference specific to the type of travel recommendation requested.

3. The computer-implemented method of claim 1, further comprising:
selecting, with the analytical model, a plurality of case-specific user analysis models from a plurality of trained models, wherein the selection is based, at least in part on, a second user query;
generating, with the selected plurality of case-specific user analysis models, a plurality of user travel preferences; and
generating, with the prompt generator, a combined prompt for the generative AI model based, at least in part, on the plurality of user travel preferences.

4. The computer-implemented method of claim 1 further comprising:
refining, with the prompt generator, the hyper-personalized prompt with data obtained from the user information data store, including at least one of a user preference, user history, or query-specific information.

5. The computer-implemented method of claim 1, further comprising:
storing, in the user information data store, data corresponding to a selection from the personalized travel recommendation; and
updating the user profile data based on the data stored in the user information data store.

6. The computer-implemented method of claim 1, further comprising:
storing, in the user information data store, data corresponding to user interactions with the personalized travel recommendation; and
updating the analytical model based on the stored data.

7. The computer-implemented method of claim 1, further comprising:
receiving, from the computing device, data corresponding to a user selection of the personalized travel recommendation; and
storing the data in the user information data store.

8. The computer-implemented method of claim 1, wherein:
the analytical model comprises a trip-agnostic user analysis model,
the hyper-personalized prompt is generated based as least in part on the output of the trip-agnostic user analysis model, the user query and static user information accessed from the user information data store, and
the static user information includes at least one of user demographic information, user general travel budget, or user typical airport of origin.

9. A non-transitory computer-readable medium storing instructions that, when executed by a processor, cause the processor to perform operations comprising:
accessing, from a data store, user data including historical travel information;
determining, with an analytical model, a user travel preference based, at least in part, on the historical travel information;
generating, with a prompt generator, a hyper-personalized prompt for a computational model, wherein the hyper-personalized prompt is generated based at least in part on the user travel preference and a request to generate a travel recommendation; and
generating, with the computational model, the travel recommendation based, at least in part, on the hyper-personalized prompt.

10. The non-transitory computer-readable medium of claim 9, further comprising:
selecting, with the analytical model, a case-specific user analysis model from a plurality of trained analytical models based, at least in part, on the request to generate the travel recommendation;
determining, with the selected case specific user analysis model, a refined user travel preference based, at least in part, on a type of the requested travel recommendation; and
providing the refined user travel preference to the prompt generator.

11. The non-transitory computer-readable medium of claim 10, further comprising:
selecting, with the analytical model, an additional case specific user analysis model from the plurality of trained analytical models based, at least in part, on the request to generate the travel recommendation;
combining, with the prompt generator, into a combined refined user travel preference, the refined user travel preference from the selected case specific user analysis model and an output from the additional case specific user analysis model; and
generating, with the prompt generator, a combined hyper-personalized prompt for the computational model based, at least in part on, the combined refined user travel preference and the request to generate the travel recommendation.

12. The non-transitory computer-readable medium of claim 11, further comprising:
refining, with the prompt generator, the combined hyper-personalized prompt, wherein the combined hyper-personalized prompt is refined with additional data accessed from the data store, and where the additional data includes at least one of general travel preferences or query-specific information; and
providing the refined combined hyper-personalized prompt to the computational model for generating the travel recommendation.

13. The non-transitory computer-readable medium of claim 9, further comprising:
storing, in the data store, data corresponding to a user selection of the generated travel recommendation; and
updating the user data based, at least in part on, the stored user selection.

14. A system comprising:
a memory that stores specific computer-executable instructions; and
a processor in communication with the memory, wherein the processor is to execute the specific computer-executable instructions to at least:
receive, from a user device, a first query requesting travel recommendations;
retrieve data from a data store, wherein the data includes historical travel information;
select, from a plurality of case-specific user analysis models, a case-specific user analysis model trained on data corresponding to the first query;
determine, with the selected case-specific user analysis model, a user travel preference based, at least in part on, the historical travel information and the first query;
generate, with a prompt generator, a hyper-personalized prompt for a large language model (LLM), wherein the hyper-personalized prompt is generated based, at least in part, on an output of the selected case-specific user analysis model and the first query; and
generate, with the LLM, a personalized travel recommendation based, at least in part on, the hyper-personalized prompt.

15. The system of claim 14, wherein the processor is to further execute the specific computer-executable instructions to at least:
select, with an analytical model, an additional case-specific user analysis model from the plurality of case-specific user analysis models based, at least in part on, the first query; and
determine, with the additional case-specific user analysis model, a refined user travel preference specific to a type of travel recommendation requested in the first query.

16. The system of claim 15, wherein the processor is to further execute the specific computer-executable instructions to at least:
select, from the plurality of case-specific user analysis models, multiple case-specific user analysis models based, at least in part, on a second query received from the user device, wherein the second query; and
determine, with the multiple case-specific user analysis models, a refined user travel preference specific to the second query.

17. The system of claim 14, wherein the selected case-specific user analysis model comprises a trip-agnostic user analysis model configured to infer contextual details about the first query, including at least one of a number of people joining a user for a meal, a cuisine type preference, and a price preference, based at least in part on the retrieved historical travel information.

18. The system of claim 14, wherein the case-specific user analysis model is configured to execute batch operations in response to new user travel information stored in the data store.

19. The system of claim 14, wherein the processor is to further execute the specific computer-executable instructions to at least:
store, in the data store, data corresponding to a user selection of the generated personalized travel recommendation; and
update the historical travel information based, at least in part, on the data stored in the data store.

20. The system of claim 14, wherein the case-specific user analysis model is configured to:
generate an embedding based on the travel preferences and the first query, wherein the embedding is provided to the LLM as supplemental input; and
reduce computational load on the LLM by combining the embedding with the hyper-personalized prompt generated by the prompt generator.
